(19) United States
(12) Patent Application Publication
(10) Pub. No.: US 2021/0377063 A1
(43) Pub. Date: Dec. 2, 2021

(54) INCLUSIVENESS AND EFFECTIVENESS FOR ONLINE MEETINGS

(71) Applicant: Microsoft Technology Licensing, LLC, Redmond, WA (US)

(72) Inventors: Ross Garrett Cutler, Clyde Hill, WA (US); Yasaman Hosseinkashi, Kirkland, WA (US)

(21) Appl. No.: 17/333,386

(22) Filed: May 28, 2021

Related U.S. Application Data
(60) Provisional application No. 63/031,939, filed on May 29, 2020.

(51) Int. Cl. H04L 12/18; G06F 3/0484; G06F 3/0482

(52) U.S. Cl. CPC H04L 12/1831; G06F 3/04842; G06F 3/0482; H04L 12/1827; H04L 12/1818

(57) ABSTRACT

A system or method may be used to improve effectiveness or inclusiveness of a communication session. A method may include identifying first parameters for the communication session and determining at least one second parameter as an output of a multivariate model using the first parameters as an input, the at least one second parameter output from the multivariate model based on the at least one second parameter having, compared to at least one of the first parameters, a higher likelihood of achieving inclusiveness. In an example, at least one graphical control may be generated for changing one of the first parameters to the at least one second parameter.

### CLAIM OF PRIORITY

This application claims the benefit of priority to U.S. Provisional Patent Application Ser. No. 63/031,939, filed May 29, 2020, titled “INCLUSIVENESS AND EFFECTIVENESS FOR ONLINE MEETINGS,” which is hereby incorporated herein by reference in its entirety.

### BACKGROUND

Millions of online meetings occur each year in the United States alone, with employees spending several hours per week in meetings, and managers spending even more. Many of those meetings have low ratings by the participants resulting in organizations using large amounts of resources on ineffective meetings each year.

Computer-mediated communication systems, especially voice-over Internet Protocol (VoIP) and video conferencing systems, have transformed how companies and organizations have meetings. Most recently such systems have enabled hundreds of millions of people to work at home remotely.

### TECHNICAL FIELD

This document pertains generally, but not by way of limitation, to online communication, and more particularly to inclusiveness and effectiveness for online meetings.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of a communication service with a multivariate model to improve inclusion and effectiveness for online meetings, in accordance with some embodiments.

FIG. 2A illustrates an example multivariate model, in accordance with some embodiments.

FIGS. 2B-2E illustrate the graph structure sequentially from an initial stage to a completed graph, in accordance with some embodiments.

FIG. 3 illustrates a flowchart of a technique for improving effectiveness and inclusiveness for a communication session, in accordance with some embodiments.

FIG. 4 illustrates a block diagram of an example machine which may implement one or more of the techniques discussed herein, in accordance with some embodiments.

### DETAILED DESCRIPTION

As stated above, many meetings are ineffective or are not inclusive. Improving meeting effectiveness is a great economic investment for companies, especially as meetings are also an embodiment of a company's culture.

A goal of remote collaboration tools is to provide the most effective meetings possible for all meeting participants. To study meeting effectiveness and meeting inclusion, a large scale email survey may be conducted. Using data from this survey, a multivariate model of meeting effectiveness may be created to correlate meeting effectiveness with meeting inclusion, participation, and feeling comfortable to contribute to the meeting (“comfortableness”). In some examples, the model may be built using machine-learning in addition to, or in place of, the large survey data. The model shows the following factors are correlated with inclusion, effectiveness, participation, and comfortableness: Sending of pre-meeting communication, sending of a post-meeting summary, including a meeting agenda, attendee location, remote-only meetings, audio/video quality and reliability, video usage, and meeting size. The model and survey results give a quantitative understanding of how and where to improve meeting effectiveness and inclusion and what the potential returns are.

A primary goal of remote communication session systems is to provide the most effective meetings possible for all participants. Disclosed herein are measurements and analyses of inclusion in meetings, including how much inclusion impacts meeting effectiveness, what makes meetings more or less effective and inclusive, how the computer-mediated communication system impacts meeting effectiveness and inclusion, and how meeting effectiveness and inclusion can be measured in a computer-mediated communication system.

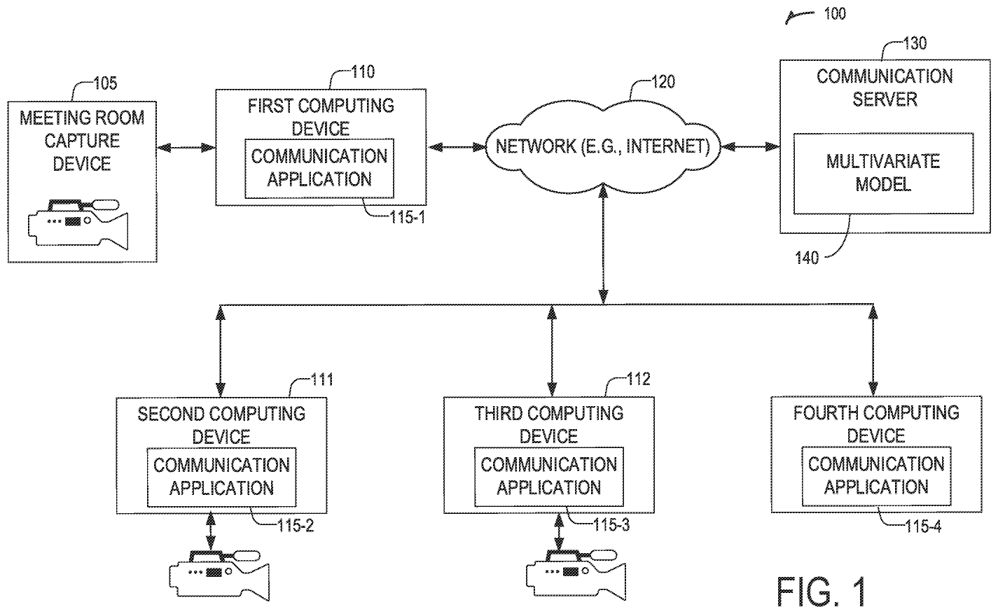

FIG. 1 is a block diagram illustrating a communication service 100 that uses a multivariate model and other effectiveness and inclusion (EI) data to provide features and controls to improve inclusion and effectiveness for online meetings. First computing device 110, second computing device 111, third computing device 112, and fourth computing device 113 may be members of a same active network-based communication session (e.g., a video conferencing session) provided by a communication server 130 and the respective instances of communication application 115. First computing device 110 may execute a first instance of a communication application 115 (shown as 115-1), second computing device 111 may execute a second instance of the communication application 115 (shown as 115-2), third computing device 112 may execute a third instance of the communication application 115 (shown as 115-3), and fourth computing device 113 may execute a fourth instance of communication application 115 (shown as 115-4).

Communications applications 115 may communicate with the communication server 130 to setup, join, and participate in the network-based communication session. This includes sending, receiving and presenting one or more of voice, video, and content data that is part of the network-based communication session. In some examples, one or more of the computing devices 110, 111, 112, and 113 may contain or be communicatively coupled to a video capture device, such as a video camera. In some examples, the video capture device may be in the form of a meeting room capture device 105—which is shown in FIG. 1 as being coupled to the first computing device 110. The meeting room capture device 105 may be a camera, a set of cameras, a 360-degree camera, or the like that may capture a large portion of the room.

First computing device 110, second computing device 111, third computing device 112, and fourth computing device 113 may execute instances of the communication application 115, denoted as 115-1, 115-2, 115-3, and 115-4 respectively. These instances of communication application 115 may also communicate with the communication server 130 to setup, join, and participate in a network-based communication session. This includes sending, receiving and presenting one or more of voice, video, and content data that is part of the network-based communication session. Collectively, the communication applications 115 and the communication server 130 provide for the network-based communication session by communicating over the network 120.

Second, third, and fourth computing devices 111, 112, and 113 respectively may or may not be communicatively coupled to a video capture device. As shown in FIG. 1, second computing device 111 and third computing device 112 are coupled to video cameras, however fourth computing device is not coupled to a video camera. Communication server 130 may process the one or more video streams from the first, second, third, and fourth computing devices 110, 111, 112, and 113 respectively.

The communication server 130 may provide a communication service which provides Microsoft Teams meetings, for example, and the communication applications 115-1, 115-2, 115-3, and 115-4 may be Microsoft Teams clients, for example. The communication server 130 may also include one or more applications, such as an application that implements a multivariate model 140, and may provide one or more features to improve effectiveness and inclusiveness for online meetings, such as is described below. The communication server 130 may also include one or more applications that act on the multivariate model 140 and/or collect further data regarding effectiveness and inclusiveness (“EI data”), such as a survey generator. The first, second, third, and fourth computing devices 110, 111, 112, and 113 may subscribe to receive one or more recommendations and/or features from the communication server 130 to improve meeting effectiveness, inclusiveness, and comfortableness based on the multivariate model 140. In some examples, the communication server 130 may set meeting defaults, or update meeting parameters automatically using the multivariate model 140.

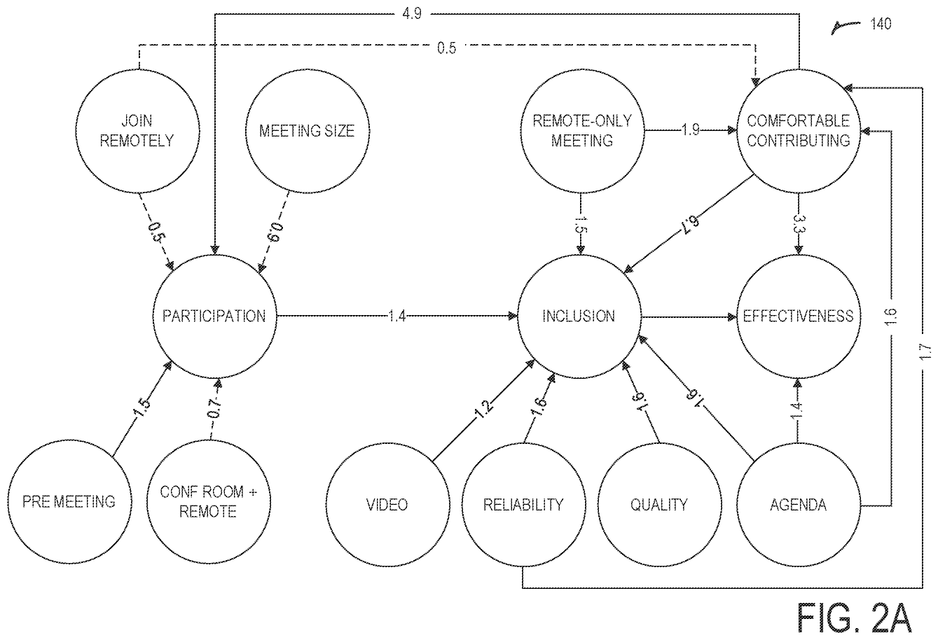

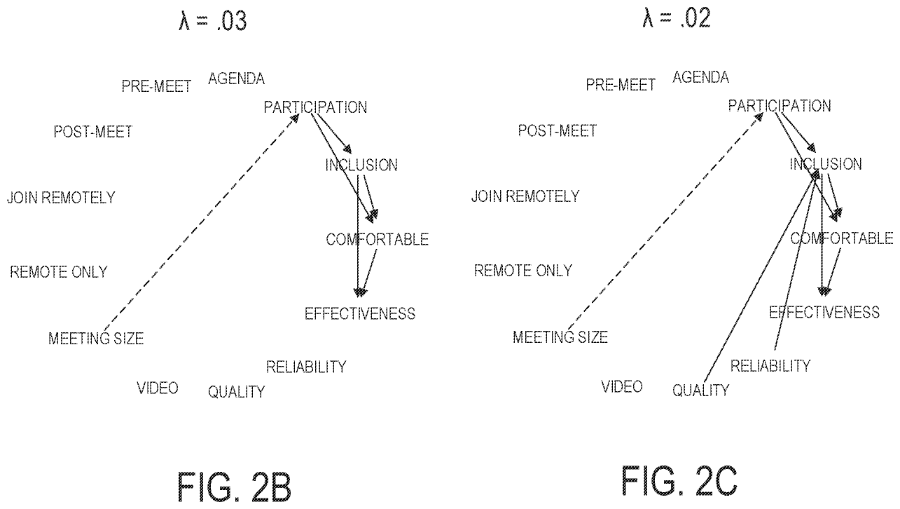

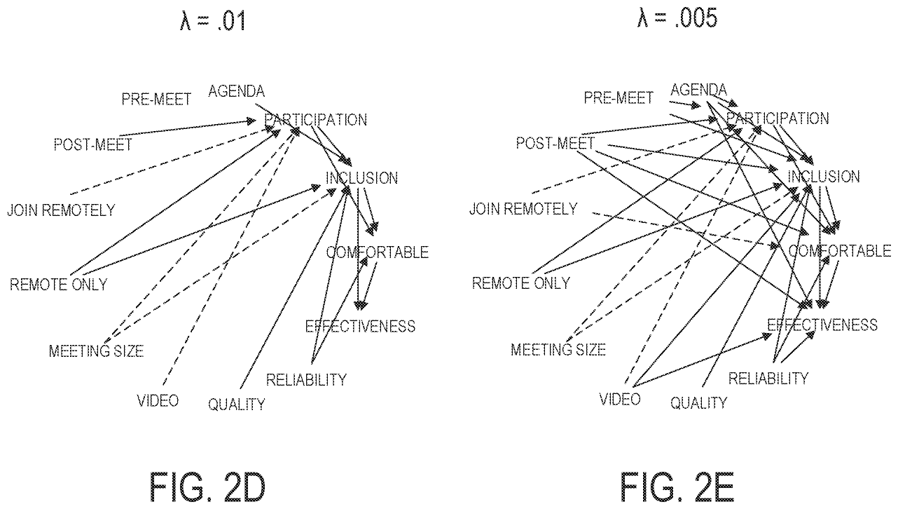

FIG. 2A illustrates an example multivariate model 140 (dashed lines illustrate negative correlation, and solid lines illustrate positive correlation). In some examples, to build the multivariate model 140, an initial meeting survey study may be performed that illustrates how meeting effectiveness and inclusion may be measured in a computer-mediated communication system and what factors are correlated to them. In one example, a 17-question survey completed by N=4,425 employees at a large technology company may be used. Initially, this data may be provided for a univariate analysis to show which relationships are significant to effectiveness and inclusion. For sample survey questions and a sample univariate analysis, see Appendices A and B. Although the univariate analysis is indicative of local structures in the survey data, it may not be adequate to explain the drivers of meeting effectiveness. This may be true for any data in which there are multi-way dependencies between random variables.

To account for inter-factor relationships, a multivariate model 140 that shows the odds ratios and significance for the factors that are correlated to meeting effectiveness, inclusion, and feeling comfortable to contribute to the meeting may be generated. A sensitivity analysis may be performed on the multivariate model 140 which illustrates which relationships are the most robust. The survey may also include suggestions to improve meeting effectiveness, inclusion, and comfortableness. The survey results and models provide a quantitative understanding of how and where to improve meeting effectiveness and inclusion along with potential returns.

Factors relating to meeting effectiveness may include inclusion, comfortable contributing, video, agenda, pre/post-meeting, location, size, AV quality, reliability, and the like. Various types of surveys may be used to obtain data regarding these factors. In some examples, inclusiveness may be defined as: “in an inclusive meeting everyone gets a chance to contribute and all voices have equal weight.”

In a graphical model, such as the multivariate model 140, nodes represent variables and edges carry information regarding the conditional probability distributions. In practice, applying a graphical model involves two main steps: (1) learning the graph structure, (2) estimating the parameters of the edges. An algorithm based on l1-regularized logistic regressions may be used to estimate the graph structure. The algorithm may involve finding each node's neighborhood using lasso regression and may be shown to provide consistent estimations. This approach has been shown to closely estimate the exact procedure through extensive simulations.

FIGS. 2B-2E illustrate the graph structure sequentially from an early stage graph (2B) to a later or completed graph (2E). In some examples, the problem of finding the graph structure may be reduced to finding the optimum neighbors for each outcome variable. In one example, a logistic regression with l1-penalized log-likelihood optimization via package glmnet may be used. If the coefficient estimated by the model for a particular outcome variable is non-zero, then there is a directed edge from that predictor to the outcome variable. When α=0 in glmnet, the model optimizes for:

l(Y,BX)+λ[(1−α)∥B∥₂²/2+α∥B∥₁] [1]

Where B, X and Y represent linear coefficients, input variables, and outcome variable respectively and l stands for negative log-likelihood function. Parameter λ controls the strength of regularization: setting λ to zero results in no regularization, hence a dense graph with all edges present between predictors and outcomes. As λ is increased, the graph becomes sparser. A few examples are shown in FIGS. 2B-2E (dashed lines illustrate negative correlation, and solid lines illustrate positive correlation). Note that with aggressive regularization, mainly edges between the outcome variables remain in the graph in addition to meeting size. This confirms the strong connection between the concepts of inclusion, comfortableness to contribute, participation, and effectiveness, as well as the choice of them as the set of outcome variables to be modeled by other variables in the survey.

To get a single graph structure, a lambda value is chosen. λ can be tuned locally using cross-validation to minimize misclassification error. The global value for λ may be set to a small number that falls in the optimum range for all models obtained by 10-fold cross-validation, for example. This may conclude step (1) by fixing a set of potential edges, i.e. the graph structure. The next step is to fit the graph and estimate the coefficients or weights for each edge.

In some examples, a weight parameter may be estimated for each edge that describes the strength of the connection between two ends given the value for all other nodes in the neighborhood. It may also be desirable to have a measure of uncertainty associated with this parameter. Hence, a logistic regression may be applied without regularization. The linear coefficients of logistic regression (βᵢ) quantify the amount of increase in the log odds ratios (log ORs) of the outcome as a result of the input variable being True, if all other variables are kept constant. For explanatory purposes, γᵢ=e^{β}^{ᵢ} may be used as edge weights which represent the change in OR instead of log OR. The values γᵢ may be considered as adjusted Odds Ratios, different from univariate ones. They represent the adjusted effect of individual input variables on the odds of outcome conditional on the other input variables in the model. The p-values of the model coefficients βᵢ may be used to drop insignificant edges if any.

The multivariate model 140 illustrates the fitted graph with the regularization parameter set to 0.005 and all edges statistically significant at 95% confidence level. The fitted graph shown in FIGS. 2B-2E include four models. Table 1 contains the linear coefficients of these models.

TABLE 1
regression coefficients and respective p. values of fitted graph

| | Outcome | | | |
|---|---|---|---|---|
| Input Variable | Variable | β | p. value | Robustness |
| Inclusive | Comfortable | 1.89 | 0.00 | 100% |
| JoinRemotely | Comfortable | −0.29 | 0.02 | 99% |
| Participation | Comfortable | 1.37 | 0.00 | 100% |
| PostMeet | Comfortable | 0.32 | 0.01 | 45% |
| Reliability | Comfortable | 0.42 | 0.00 | 97% |
| Agenda | Effectiveness | 0.28 | 0.02 | 100% |
| Comfortable | Effectiveness | 1.27 | 0.00 | 100% |
| Inclusive | Effectiveness | 0.76 | 0.00 | 100% |
| Agenda | Inclusive | 0.51 | 0.00 | 100% |
| RemoteOnlyMeeting | Inclusive | 0.51 | 0.00 | 100% |
| Participation | Inclusive | 0.92 | 0.00 | 100% |
| Quality | Inclusive | 0.38 | 0.01 | 100% |
| Reliability | Inclusive | 0.70 | 0.00 | 100% |
| Video | Inclusive | 0.21 | 0.04 | 82% |
| JoinRemotely | Participation | −0.86 | 0.00 | 100% |
| MeetingSize | Participation | −0.09 | 0.00 | 100% |
| RemoteOnlyMeeting | Participation | 0.57 | 0.00 | 100% |
| PostMeet | Participation | 0.50 | 0.00 | 100% |
| PreMeet | Participation | 0.26 | 0.05 | 47% |

As revealed in initial results and through regularization steps, the data suggests comfortableness and inclusion are strongest drivers of meeting effectiveness. The odds of a meeting being effective is 2.1 times higher if it is inclusive and 3.3 times higher if attendees feel comfortable participating. However, inclusion is shown to be statistically correlated with A/V quality and reliability, use of agenda and whether the meeting is all remote or involves a conference room. According to the data, the odds of having an effective meeting are 30% higher if the meeting has an agenda. Also, the odds of being inclusive are 70% higher if it does not involve a meeting room.

There may be other factors not included in this example model that impact effectiveness and inclusion, such as meeting type (e.g., sales, brainstorming, project review, etc.), attendee personalities and relationships, quality of facilitation, and attendee diversity, which may also be included in one or more other example models. The multivariate model 140 helps provide guidance for investing to improve meeting effectiveness and inclusion and what potential returns are. The above also provides the following insights (adjusted odds ratios (γ values) included in parenthesis):

According to this analysis, meetings may be most effective when: attendees feel comfortable participating (3.6), they are inclusive (2.1), an agenda is included (1.3). Meetings are most inclusive when: an agenda is included (1.7), the AV quality and reliability is good (1.5, 2.0), it is a remote-only meeting (1.7), attendees speak more than once (2.5), attendees see video of others (1.2). Attendees most feel comfortable contributing when: They are inclusive (6.6), attendees feel comfortable participating (3.9), they are not joining remotely (0.4), the AV is reliable (1.7), an agenda is included (1.5). Attendees participate most when: a pre-meeting read is sent (1.3), they don't join remotely when the meeting is not remote-only (0.4), meeting is remote only (1.7), the meetings are not large (0.9).

Graphical models are powerful tools to model multi-layer survey data. For the model 140, a general approach may be used that can be used to fit both directed and undirected graphs. An advantage of this method is to infer a more descriptive structure. In other examples, Bayes Networks may be used to analyze such data (See Appendix B). The main characteristic of Bayesian networks is that the space of graphs is restricted to directed acyclic networks. Thus, Bayesian networks may be helpful as predictive models, but may lack the descriptive power of approaches relying on generalized linear models.

For the multivariate model 140, note that “post meet” is correlated to both “participation” and “comfortable contributing”. This relationship is not causal, but rather indicates that meetings that include post-meeting communications are ones that attendees both feel more comfortable contributing to and participate in. It may be that these meetings are well executed by a meeting organizer or facilitator, who not only sent a summary of the meeting but also helped facilitate the meeting.

One method of measuring meeting effectiveness, inclusiveness, and comfortableness is to provide a post-meeting survey. One example survey may include one or more of the following questions:

1. How effective was the meeting at achieving the business goals?

a. Very ineffective

b. Ineffective

c. Neither effective nor ineffective

d. Effective

e. Very effective

2. How inclusive was the meeting? In an inclusive meeting everyone gets a chance to contribute and all voices have equal weight.

a. Not at all inclusive

b. Not inclusive

c. Neither inclusive or exclusive

d. Inclusive

e. Very inclusive

3. How comfortable did you feel contributing to the meeting?

a. Very uncomfortable

b. Uncomfortable

c. Neither comfortable nor uncomfortable

d. Comfortable

e. Very comfortable

4. How inclusive was the meeting? In an inclusive meeting everyone gets a chance to contribute and all voices have equal weight.

a. Not at all inclusive

b. Not inclusive

c. Neither inclusive or exclusive

d. Inclusive

e. Very inclusive

5. How comfortable did you feel contributing to the meeting?

a. Very uncomfortable

b. Uncomfortable

c. Neither comfortable nor uncomfortable

d. Comfortable

e. Very comfortable

6. How many people attended the meeting (approximately)?

7. Did you join in a conference room or remotely?

a. Conference room

b. Remotely

8. Did you receive video of other participants in the meeting?

a. Yes

b. No

9. How much did you participate in the meeting?

a. I only listened

b. I spoke up once

c. I spoke a few times

d. I spoke up many times

10. Did the meeting have an agenda with the meeting purpose and goals in the meeting invitation?

a. Yes

b. No

11. Did the meeting have any pre-meeting reading sent out before the meeting (e.g., slides, documents)?

a. Yes

b. No

12. Did the meeting have any post-meeting summary or action items sent out?

a. Yes

b. No

13. If you used <anonymous audio/video communication application> in the meeting how was the audio/video call quality?

a. Excellent

b. Good

c. Fair

d. Poor

e. Very bad

14. If you used <anonymous audio/video communication application> in the meeting how was the call reliability (meeting join, call drops, screen share worked, etc.)?

a. Excellent

b. Good

c. Fair

d. Poor

e. Very bad

15. What would have made the meeting more effective?

a. More participation from everyone

b. Including a meeting agenda and roles

c. Sending pre-meeting reading

d. Sending a post-meeting summary

e. Better time management

f. Including all required participants

g. Better audio/video quality

h. Better audio/video reliability

i. More people using video

j. Other

16. What would have made the meeting more inclusive?

a. More participation from everyone

b. Including a meeting agenda and roles

c. Sending pre-meeting reading

d. Better tone of voice and word choice

e. Including all required participants

f. Better audio/video quality

g. Better audio/video reliability

h. Better ability for remote participants to interrupt and talk

i. More people using video

j. Other

17. What would have made it more comfortable to participate in the meeting?

a. Including a meeting agenda and roles

b. Sending pre-meeting reading

c. Better tone of voice and word choice

d. Better audio/video quality

e. Better audio/video reliability

f. Better ability for remote participants to interrupt and talk

g. More people using video

h. Other

In one example, the survey may be provided using one or more forms and may be provided to participants of the meeting through a meeting chat, for example.

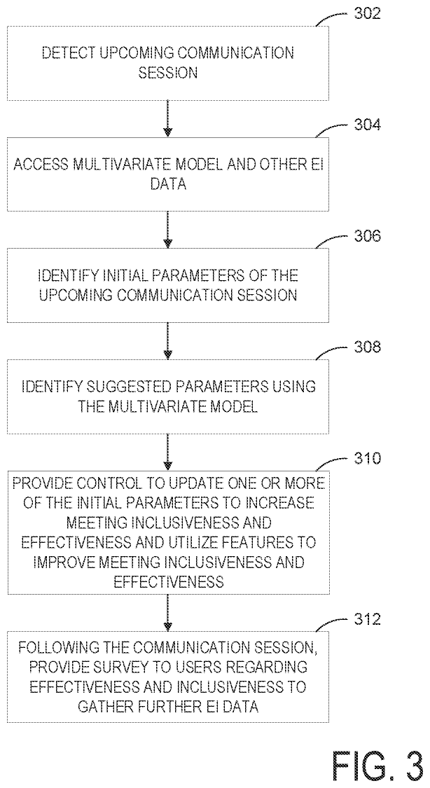

FIG. 3 is a flowchart illustrating a method 300 of improving inclusiveness, effectiveness and comfortableness for online communication sessions using a multivariate model and/or other EI data. At step 302, an upcoming online communication session is optionally identified. At step 304, a multivariate model, such as the model 140, may be accessed along with other effectiveness and inclusiveness (EI) data. This data may include data gathered from user surveys, data gathered automatically or manually during communication sessions, or the like. The multivariate model may have been generated using initial survey data or any other data as discussed herein and may be updated using further EI data. At step 306, initial parameters are identified for the upcoming communication session. The initial parameters may include one or more of whether an agenda is included for the meeting, whether a physical conference room is specified for the meeting, whether one or more users are using video for the communication session, a number of invited attendees, and the like.

At step 308, one or more suggested parameters are identified using the initial parameters and the multivariate model. For example, the suggested parameters may include a reduced number of attendees, provision of an agenda, removal of a physical meeting room, and the like. Step 308 may include determining the one or more suggested parameters as an output of a multivariate model using the first parameters as an input. The one or more suggested parameters may be output from the multivariate model based on the one or more suggested parameters having a higher likelihood of achieving an inclusiveness metric compared to an initial parameter. The multivariate model may be generated using past communication session parameters and inclusiveness metrics.

At step 310, a user interface may be presented to a meeting organizer with a control to update one or more of the initial parameters using one or more of the suggested parameters. In some examples, a simple message may be provided suggesting the updated parameters. In some examples, default parameters may be set for a meeting using the suggested parameters. In some examples, parameters may be automatically updated using the suggested parameters. In one example, upon scheduling a meeting, meeting organizers may be notified if they are missing anything that helps make the meeting more effective and inclusive (EI), such as including an agenda, pre-meeting communication, a meeting link, and post-meeting summaries.

In an example, selection of the at least one graphical control causes at least one of activation of an automated communication session facilitator, a notification to be sent to attendees encouraging the attendees to turn on their video, a reminder to be sent to a communication session organizer to call on remote users, a reminder to be sent to the communication session organizer to send a post-session summary, or the like.

In addition to providing users with suggestions, various features may be implemented and provided for the communication service to improve effectiveness and inclusiveness based on the analysis discussed herein. In some examples, to increase meeting effectiveness, the following may be utilized: increase meetings with pre-meeting communication and post-meeting summary, such as using reminders to send pre-meeting and post-meeting communication; increase meetings with agendas, such as using reminders or policy to require meeting agendas with time templates; better time management, such as providing a time management tool using agenda time targets; and use of analytics reports with meeting effectiveness statistics and recommendations.

In some examples, to increase meeting inclusiveness, the following features may be utilized. First, helping remote users speak. For example, creating an Automated Meeting Facilitator (AMF) that can help remote users get the floor. The facilitator may detect when a remote person is trying to speak (automatically or manually) and then can interrupt in the next pause in the conversation (optionally at the end of a sentence). The AMT may run locally in the meeting room so it does not have the delay that remote participants have; this delay is a primary cause remote interrupting is so challenging. The AMF acts as an expert facilitator for helping remote users speak. Additionally, creating a low-latency active speaker display to help remote participants get the speaking floor. Further, alerting the meeting facilitator when the average #speakers>>1. When there are no gaps in the conversation it is very difficult for the remote participants to get the speaking floor, which is reflected in the odds ratio of 0.5 for remote attendees participating (see FIG. 2A). Also, implementing user-specific noise suppression so that users do not have to mute themselves to avoid inducing background noise. When attendees are muted they are much less likely to participate in the meeting.

To increase meeting inclusiveness, features may be implemented to promote more video use. For example, displaying the remote video and roster for the single-display conference room scenario. Also, reminding/recommending users to use video and have the communication client remember a previous video setting.

Features to increase participation may also be implemented to increase inclusiveness. For example, creating a roster for the meeting facilitator that shows remote participation rates. This will help the facilitator decide to call on remote participants as needed. Also, raising the visibility of instant messages (IMs) sent in the meeting chat to the facilitator and meeting room system.

In an example, an inclusiveness metric may be used, for example when determining whether a second parameter increases inclusiveness compared to one of the first parameters. The inclusiveness metric may measure whether every participant in the communication session has an opportunity to contribute to the communication session with an equal weight. The inclusiveness metric may be hidden in the multivariate model (e.g., as weights or in a neural network hidden layers). In an example, the inclusiveness metric may be identified from a post-meeting survey.

At step 312, a survey is presented to users of the communication session. For example, following online communication sessions, such as video conferences, one or more survey questions may be presented to a user through a user interface. The survey questions may include selectable choices, input fields for inputting text, or any other method of answering the questions through the user interface. The questions may include any of the questions discussed herein, such as those in Appendices A and B. In an example, the multivariate model may be updated using results of the survey (e.g., along with parameters from the meeting, which may be saved together).

In an example, likely effectiveness or inclusiveness for the communication session may be estimated using the multivariate model and the initial parameters (and optionally any replacement parameters used). The likely effectiveness or inclusiveness may be displayed on the user interface, such as to an organizer or human facilitator of the communication session. In an example, the likely effectiveness or inclusiveness may be updated on the user interface when a parameter is changed (e.g., when a control is selected to change a parameter, based on a suggested change). In an example, the update may be displayed in real-time. In an example, a post meeting summary may be sent indicating an increase in effectiveness or inclusiveness that was attainable for the meeting with different parameters. In this example, a suggestion may be provided for a parameter for a future meeting.

Additional data may be gathered automatically during the meeting. For example, artificial intelligence and/or machine learning may be used to identify one or more of: average number of speakers based on voice analysis, participation rate, male/female participation rate based on voice analysis, multitasking during meetings, and male/female interruption ratio based on voice analysis. Some or all of these may be determined using voice analysis during the meeting, or after the meeting using one or more recordings. Example machine-learning algorithms may include logistic regression, neural networks, decision forests, decision jungles, boosted decision trees, support vector machines, and the like.

The survey and other data may also be used to create analytics reports, for example, to show how effective and inclusive meetings are, with suggestions how to improve them. Meeting organizations can use these analytics to analyze overall company and organization meeting effectiveness and inclusion, with recommendations for each.

In an example, the first parameters include at least one of whether a pre-session communication was sent, whether a post-session summary was sent, whether a communication session agenda was included, an attendee location, whether the communication session was remote-only, an audio quality metric, a video quality metric, an audio reliability metric, a video reliability metric, whether video was used, a communication session size, or the like.

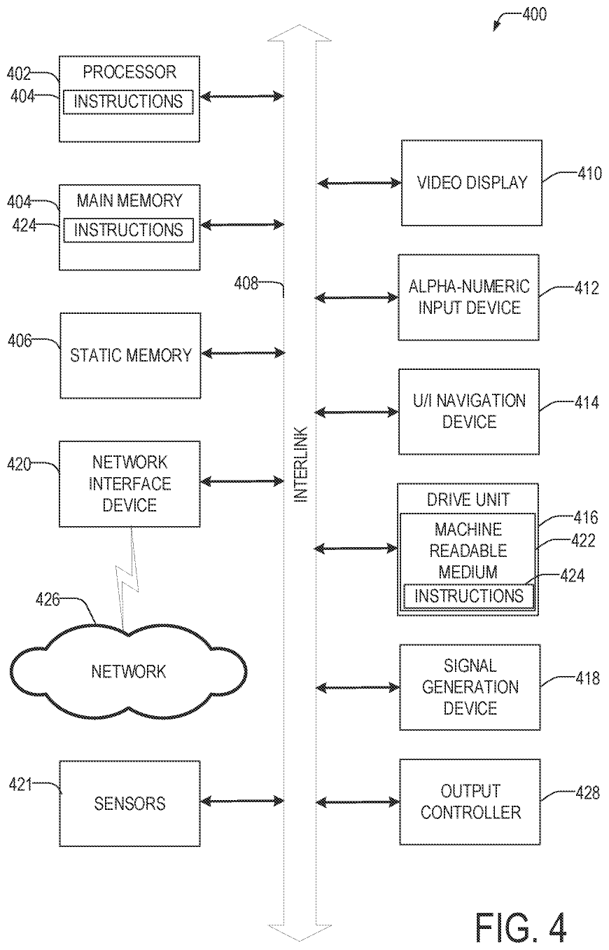

FIG. 4 illustrates a block diagram of an example machine 400 upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may implement a communication server 130, a computing device (such as first, second, third, or fourth computing devices 110, 111, 112, and 113 of FIG. 1), or the like. The machine may implement the multivariate model of FIG. 2 and devices used in executing the method of FIG. 3. The machine 400 may take the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 424 may further be transmitted or received over a communications network 426 using a transmission medium via the network interface device 420. The Machine 400 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

Each of these non-limiting examples may stand on its own, or may be combined in various permutations or combinations with one or more of the other examples.

Example 1 is a method of improving effectiveness and inclusiveness for a communication session, the method comprising: identifying first parameters for the communication session; determining at least one second parameter as an output of a multivariate model using the first parameters as an input, the at least one second parameter output from the multivariate model based on the at least one second parameter having, compared to at least one of the first parameters, a higher likelihood of achieving an inclusiveness metric, the multivariate model generated using past communication session parameters and inclusiveness metrics; generating at least one graphical control for changing one of the first parameters to the at least one second parameter; and presenting the at least one graphical control through a user interface.

In Example 2, the subject matter of Example 1 includes, estimating a likely effectiveness and a likely inclusiveness for the communication session using the multivariate model and the first parameters; and displaying the likely effectiveness and the likely inclusiveness on the user interface to an organizer of the communication session.

In Example 3, the subject matter of Example 2 includes, updating a likely effectiveness and a likely inclusiveness for the communication session using the second parameter as a replacement for the one of the first parameters; and displaying the updated likely effectiveness and the updated likely inclusiveness on the user interface to an organizer of the communication session.

In Example 4, the subject matter of Examples 1-3 includes, receiving a selection on the user interface of the at least one graphical control; and in response, replacing the one of the first parameters with the at least one second parameter.

In Example 5, the subject matter of Examples 1-4 includes, receiving a selection on the user interface of the at least one graphical control; and in response, outputting an indication on the user interface, the indication identifying how to replace the one of the first parameters with the at least one second parameter.

In Example 6, the subject matter of Examples 1-5 includes, presenting a plurality of questions to a user of the communication session following completion of the communication session, the plurality of questions regarding effectiveness and inclusiveness and presented through a user interface; using responses by the user to the plurality of questions to determine effectiveness and inclusiveness of the communication session; and saving the determined effectiveness and inclusiveness of the communication session with parameters used for the communication session.

In Example 7, the subject matter of Example 6 includes, updating the multivariate model using the determined effectiveness and inclusiveness.

In Example 8, the subject matter of Examples 1-7 includes, wherein the first parameters include at least one of whether a pre-session communication was sent, whether a post-session summary was sent, whether a communication session agenda was included, an attendee location, whether the communication session was remote-only, an audio quality metric, a video quality metric, an audio reliability metric, a video reliability metric, whether video was used, or a communication session size.

In Example 9, the subject matter of Examples 1-8 includes, wherein the inclusiveness metric measures whether every participant in the communication session has an opportunity to contribute to the communication session with an equal weight.

In Example 10, the subject matter of Examples 1-9 includes, wherein selection of the at least one graphical control causes at least one of activation of an automated communication session facilitator, a notification to be sent to attendees encouraging the attendees to turn on their video, a reminder to be sent to a communication session organizer to call on remote users, or a reminder to be sent to the communication session organizer to send a post-session summary.

Example 11 is at least one machine-readable medium including instructions for improving effectiveness and inclusiveness for a communication session, the instructions causing a processor to implement operations to: identify first parameters for the communication session; determine at least one second parameter as an output of a multivariate model using the first parameters as an input, the at least one second parameter output from the multivariate model based on the at least one second parameter having, compared to at least one of the first parameters, a higher likelihood of achieving an inclusiveness metric, the multivariate model generated using past communication session parameters and inclusiveness metrics; generate at least one graphical control for changing one of the first parameters to the at least one second parameter; and present the at least one graphical control through a user interface.

In Example 12, the subject matter of Example 11 includes, wherein the instructions further cause the processor to: estimate a likely effectiveness and a likely inclusiveness for the communication session using the multivariate model and the first parameters; and display the likely effectiveness and the likely inclusiveness on the user interface to an organizer of the communication session.

In Example 13, the subject matter of Example 12 includes, wherein the instructions further cause the processor to: update a likely effectiveness and a likely inclusiveness for the communication session using the second parameter as a replacement for the one of the first parameters; and display the updated likely effectiveness and the updated likely inclusiveness on the user interface to an organizer of the communication session.

In Example 14, the subject matter of Examples 11-13 includes, wherein the instructions further cause the processor to: receive a selection on the user interface of the at least one graphical control; and in response, replace the one of the first parameters with the at least one second parameter.

In Example 15, the subject matter of Examples 11-14 includes, wherein the instructions further cause the processor to: receive a selection on the user interface of the at least one graphical control; and in response, output an indication on the user interface, the indication identifying how to replace the one of the first parameters with the at least one second parameter.

In Example 16, the subject matter of Examples 11-15 includes, wherein the instructions further cause the processor to: present a plurality of questions to a user of the communication session following completion of the communication session, the plurality of questions regarding effectiveness and inclusiveness and presented through a user interface; use responses by the user to the plurality of questions to determine effectiveness and inclusiveness of the communication session; and save the determined effectiveness and inclusiveness of the communication session with parameters used for the communication session.

In Example 17, the subject matter of Example 16 includes, wherein a synchronous or an asynchronous survey is sent to a participant after the communication session has ended, and wherein the instructions further cause the processor to update the multivariate model using the determined effectiveness and inclusiveness.

In Example 18, the subject matter of Examples 11-17 includes, wherein the first parameters include at least one of whether a pre-session communication was sent, whether a post-session summary was sent, whether a communication session agenda was included, an attendee location, whether the communication session was remote-only, an audio quality metric, a video quality metric, an audio reliability metric, a video reliability metric, whether video was used, or a communication session size.

Example 19 is an apparatus for improving effectiveness and inclusiveness for a communication session, the method comprising: means for identifying first parameters for the communication session; means for determining at least one second parameter as an output of a multivariate model using the first parameters as an input, the at least one second parameter output from the multivariate model based on the at least one second parameter having, compared to at least one of the first parameters, a higher likelihood of achieving an inclusiveness metric, the multivariate model generated using past communication session parameters and inclusiveness metrics: means for generating at least one graphical control for changing one of the first parameters to the at least one second parameter; and means for presenting the at least one graphical control through a user interface.

In Example 20, the subject matter of Example 19 includes, wherein the inclusiveness metric measures whether every participant in the communication session has an opportunity to contribute to the communication session with an equal weight.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method of improving effectiveness and inclusiveness for a communication session, the method comprising:
identifying first parameters for the communication session;
determining at least one second parameter as an output of a multivariate model using the first parameters as an input, the at least one second parameter output from the multivariate model based on the at least one second parameter having, compared to at least one of the first parameters, a higher likelihood of achieving an inclusiveness metric, the multivariate model generated using past communication session parameters and inclusiveness metrics;
generating at least one graphical control for changing one of the first parameters to the at least one second parameter; and
presenting the at least one graphical control through a user interface.

2. The method of claim 1, further comprising:
estimating a likely effectiveness and a likely inclusiveness for the communication session using the multivariate model and the first parameters; and
displaying the likely effectiveness and the likely inclusiveness on the user interface to an organizer of the communication session.

3. The method of claim 2, further comprising:
updating a likely effectiveness and a likely inclusiveness for the communication session using the second parameter as a replacement for the one of the first parameters; and
displaying the updated likely effectiveness and the updated likely inclusiveness on the user interface to an organizer of the communication session.

4. The method of claim 1, further comprising:
receiving a selection on the user interface of the at least one graphical control; and
in response, replacing the one of the first parameters with the at least one second parameter.

5. The method of claim 1, further comprising:
receiving a selection on the user interface of the at least one graphical control; and
in response, outputting an indication on the user interface, the indication identifying how to replace the one of the first parameters with the at least one second parameter.

6. The method of claim 1, further comprising:
presenting a plurality of questions to a user of the communication session following completion of the communication session, the plurality of questions regarding effectiveness and inclusiveness and presented through a user interface;
using responses by the user to the plurality of questions to determine effectiveness and inclusiveness of the communication session; and
saving the determined effectiveness and inclusiveness of the communication session with parameters used for the communication session.

7. The method of claim 6, further comprising updating the multivariate model using the determined effectiveness and inclusiveness.

8. The method of claim 1, wherein the first parameters include at least one of whether a pre-session communication was sent, whether a post-session summary was sent, whether a communication session agenda was included, an attendee location, whether the communication session was remote-only, an audio quality metric, a video quality metric, an audio reliability metric, a video reliability metric, whether video was used, or a communication session size.

9. The method of claim 1, wherein the inclusiveness metric measures whether every participant in the communication session has an opportunity to contribute to the communication session with an equal weight.

10. The method of claim 1, wherein selection of the at least one graphical control causes at least one of activation of an automated communication session facilitator, a notification to be sent to attendees encouraging the attendees to turn on their video, a reminder to be sent to a communication session organizer to call on remote users, or a reminder to be sent to the communication session organizer to send a post-session summary.

11. At least one machine-readable medium including instructions for improving effectiveness and inclusiveness for a communication session, the instructions causing a processor to implement operations to:
identify first parameters for the communication session;
determine at least one second parameter as an output of a multivariate model using the first parameters as an input, the at least one second parameter output from the multivariate model based on the at least one second parameter having, compared to at least one of the first parameters, a higher likelihood of achieving an inclusiveness metric, the multivariate model generated using past communication session parameters and inclusiveness metrics;
generate at least one graphical control for changing one of the first parameters to the at least one second parameter; and
present the at least one graphical control through a user interface.

12. The at least one machine-readable medium of claim 11, wherein the instructions further cause the processor to:
estimate a likely effectiveness and a likely inclusiveness for the communication session using the multivariate model and the first parameters; and
display the likely effectiveness and the likely inclusiveness on the user interface to an organizer of the communication session.

13. The at least one machine-readable medium of claim 12, wherein the instructions further cause the processor to:
update a likely effectiveness and a likely inclusiveness for the communication session using the second parameter as a replacement for the one of the first parameters; and
display the updated likely effectiveness and the updated likely inclusiveness on the user interface to an organizer of the communication session.

14. The at least one machine-readable medium of claim 11, wherein the instructions further cause the processor to:
receive a selection on the user interface of the at least one graphical control; and
in response, replace the one of the first parameters with the at least one second parameter.

15. The at least one machine-readable medium of claim 11, wherein the instructions further cause the processor to:
receive a selection on the user interface of the at least one graphical control; and
in response, output an indication on the user interface, the indication identifying how to replace the one of the first parameters with the at least one second parameter.

16. The at least one machine-readable medium of claim 11, wherein the instructions further cause the processor to:
present a plurality of questions to a user of the communication session following completion of the communication session, the plurality of questions regarding effectiveness and inclusiveness and presented through a user interface;
use responses by the user to the plurality of questions to determine effectiveness and inclusiveness of the communication session; and
save the determined effectiveness and inclusiveness of the communication session with parameters used for the communication session.

17. The at least one machine-readable medium of claim 16, wherein a synchronous or an asynchronous survey is sent to a participant after the communication session has ended, and wherein the instructions further cause the processor to update the multivariate model using the determined effectiveness and inclusiveness and results of the survey.

18. The at least one machine-readable medium of claim 11, wherein the first parameters include at least one of whether a pre-session communication was sent, whether a post-session summary was sent, whether a communication session agenda was included, an attendee location, whether the communication session was remote-only, an audio quality metric, a video quality metric, an audio reliability metric, a video reliability metric, whether video was used, or a communication session size.

19. An apparatus for improving effectiveness and inclusiveness for a communication session, the method comprising:
means for identifying first parameters for the communication session;
means for determining at least one second parameter as an output of a multivariate model using the first parameters as an input, the at least one second parameter output from the multivariate model based on the at least one second parameter having, compared to at least one of the first parameters, a higher likelihood of achieving an inclusiveness metric, the multivariate model generated using past communication session parameters and inclusiveness metrics;
means for generating at least one graphical control for changing one of the first parameters to the at least one second parameter; and
means for presenting the at least one graphical control through a user interface.

20. The apparatus of claim 19, wherein the inclusiveness metric measures whether every participant in the communication session has an opportunity to contribute to the communication session with an equal weight.
